(19) United States
(12) Patent Application Publication
(10) Pub. No.: US 2024/0025104 A1
(43) Pub. Date: Jan. 25, 2024

(54) METHOD AND DEVICE FOR FORMING LAYERED WORKPIECE

(71) Applicant: HONDA MOTOR CO., LTD., (US)

(72) Inventors: Hiroaki Iwanishi, Tochigi (JP); Akira Taguchi, Tochigi (JP); Fuga Nagai, Tochigi (JP)

(21) Appl. No.: 17/768,572

(22) PCT Filed: Jul. 14, 2020
(86) PCT No.: PCT/JP2020/027403

§ 371 Date: Apr. 13, 2022

(30) Foreign Application Priority Data
Oct. 17, 2019 (JP) 2019-190090

(51) Int. Cl. B29C 51/36; B29C 51/14; B29C 51/10; B29C 51/26

(52) U.S. Cl. CPC B29C 51/36; B29C 51/14; B29C 51/10; B29C 51/264

(57) ABSTRACT

A method for forming a layered workpiece includes a transfer step of attaching a sheet material 44 to a second mold 30 to transfer a pattern to the sheet material 44. A first mold 20 is provided with a sucking hole 22 penetrating the first mold 20 to open at a portion that comes into contact with a workpiece body 42, a second sucking device 52 that sucks the workpiece body 42 is connected to the sucking hole 22, a hole is created, before or during sucking by the second sucking device 52, at a place on the sheet material 44 in a non-bonded region X to moderate sucking by the second sucking device 52 so that the sheet material 44 does not attach to the non-bonded region X of the workpiece body 42.

### TECHNICAL FIELD

The present invention relates to a method and a device for forming a layered workpiece.

### BACKGROUND ART

Conventionally, a layered workpiece forming device that forms a layered workpiece, which includes a workpiece body and a sheet material layered on the workpiece body, by using a first mold that suctions and holds the workpiece body has been known (see, for example, JP 7-24909 A).

In JP H7-24909 A, a clearance recess portion formed in a central portion of the workpiece body is closed by a shutter in order to prevent a sheet material from being pulled into the clearance recess portion and tom.

The degree of freedom of the layout of the workpiece body is limited when the shutter covering the clearance recess portion is provided. In this regard, there is also known what is provided with a sucking device that is positioned at the clearance recess portion formed in the central portion of the workpiece body and sucks the sheet material in a direction away from the workpiece body (see, for example, JP 2000-218688 A).

### CITATION LIST

### Patent Literature

Patent Literature 1: JP 7-24909 A
Patent Literature 2: JP 2000-218688 A

### SUMMARY OF INVENTION

### Technical Problem

Regarding a layered workpiece forming device of JP 7-24909 A, when using a second mold having, on an inner surface, a pattern that can be transferred to a surface of a sheet material, when the sheet material is suctioned by the second mold to transfer the pattern to the sheet material, and then a first mold that suctions the workpiece body is overlapped with the second mold to attach the sheet material to the workpiece body, a fluid such as air may be ejected from the second mold to make the sheet material readily detach from the second mold.

In this case, unlike JP 7-24909 A, a sucking device that is positioned at a clearance recess portion in a central portion of the workpiece body and sucks the sheet material in a direction away from the workpiece body cannot be provided. Thus, in order to improve the degree of freedom of the layout of the workpiece body, an insert may be disposed in the clearance recess portion.

Furthermore, at a periphery of the workpiece body that does not affect the degree of freedom of the layout of the workpiece body, a shutter device may be provided to prevent the sheet material from attaching to a place, on the periphery of the workpiece body, where the sheet material is not to be attached.

However, when the shutter device is provided at the periphery of the workpiece body, there is a problem that since the sheet material is gripped by a clamp disposed on the outer side of the shutter device, a sheet material having a large size considering the size of the shutter device needs to be prepared, and thus the manufacturing cost of the layered workpiece cannot be suppressed.

Furthermore, the shutter device has a complicated structure, the shutter device needs to be installed at a plurality of places, the manufacturing cost of the mold cannot be suppressed, the maintenance of the shutter device requires labor, and maintainability is low.

In view of the above issue, it is an object of the present invention to provide a method for forming a layered workpiece and a layered workpiece forming device that can suppress the manufacturing costs of the layered workpiece and the mold and improve maintainability.

### Solution to Problem

[1] To achieve the above object, a method for forming a layered workpiece of the present invention is a method for forming a layered workpiece using a layered workpiece forming device (for example, a layered workpiece forming device 1 of an embodiment. The same applies hereinafter) including
a first mold (for example, a first mold 20 of an embodiment. The same applies hereinafter) configured to suction and hold a workpiece body (for example, a workpiece body 42 of an embodiment. The same applies hereinafter), and
a second mold (for example, a second mold 30. The same applies hereinafter) having on an inner surface a pattern that can be transferred to a surface of a sheet material (for example, a sheet material 44 of an embodiment. The same applies hereinafter) to be layered on the workpiece body and configured to press the sheet material against the workpiece body,
to bond the sheet material to the workpiece body to form a layered workpiece (for example, a layered workpiece 40 of an embodiment. The same applies hereinafter),
the method including
a transfer step (for example, a transfer step of an embodiment. The same applies hereinafter) of attaching the sheet material to the second mold to transfer the pattern to the sheet material,
where
the first mold is provided with a sucking hole (for example, a sucking hole 22 of an embodiment. The same applies hereinafter) that penetrates the first mold to open at a portion that comes into contact with the workpiece body,
a sucking device for suctioning (for example, a second sucking device 52 of an embodiment. The same applies hereinafter) configured to suck the workpiece body is connected to the sucking hole, and
before or during sucking by the sucking device for suctioning, a hole is created in the sheet material in a non-bonded region to moderate sucking by the sucking device for suctioning so that the sheet material does not attach to the workpiece body in the non-bonded region that is not a bonded region.

According to the present invention, which is not provided with a shutter device, a hole is created in the sheet of a base material portion to which the sheet should not be bonded so that the first mold side and the second mold side on different sides of the sheet of a product inner plate portion have the same degree of vacuum, and this prevents the first mold side vacuum from causing the sheet to make contact with the non-bonded region of the workpiece body.

[2] In the present invention, it is preferable to form a hole in the non-bonded region of the sheet material after heating the sheet material. According to the present invention, a hole can be easily created in the sheet material.

[3] A layered workpiece forming device of the present invention includes
a first mold configured to suction and hold a workpiece body, and
a second mold having on an inner surface a pattern that can be transferred to a surface of a sheet material to be layered on the workpiece body, and configured to press the sheet material against the workpiece body,
where
a sucking hole for suctioning the workpiece body is provided in the first mold,
a sucking device for suctioning is connected to the sucking hole, and
the layered workpiece forming device includes a hole creating unit (for example, a through-hole 32 and a first sucking device 51 of an embodiment or a protrusion provided on a first mold or a second mold of the embodiment. The same applies hereinafter) configured to create, before or during sucking by the sucking device for suctioning, a hole in the sheet material in a non-bonded region (for example, a non-bonded region of an embodiment. The same applies hereinafter) to moderate sucking by the sucking device for suctioning.

According to the present invention, without adding a complicated and high cost mechanism such as a conventional shutter, a layered workpiece forming device capable of preventing a sheet material from sticking to a non-bonded region of a workpiece body by creating a hole by a hole creating unit in a portion of the sheet material that is not layered can be provided.

[4] In the present invention, it is preferable that the hole creating unit includes a through-hole provided in the inner surface of the second mold in the non-bonded region, and a sucking device for creating hole (for example, a first sucking device 51 of an embodiment. The same applies hereinafter) that sucks the sheet material through the through-hole to create a hole in the sheet material in the non-bonded region.

According to this configuration, for example, as compared with a case where a hole is formed in a sheet material by a protrusion or the like provided on the first mold or the second mold, a hole can be easily and reliably created in the sheet material to prevent the sheet material from sticking to the workpiece body in the non-bonded region.

[5] In the present invention, it is preferable that the sucking device for creating hole is the sucking device for suctioning, and a hole is created in the sheet material in the non-bonded region by sucking the sheet material via the through-hole using the sucking device for suctioning.

According to this configuration, there is no need to provide a sucking device dedicated to the hole creating unit, and a hole can be created in the sheet material simultaneously with the transfer step, for example, using an existing sucking device for pattern transfer. Therefore, the size and cost of the layered workpiece forming device can be reduced, and at the same time, forming a hole simultaneously with the transfer step can simplify the manufacturing process.

[6] In the present invention, it may be configured that the second mold includes a recess portion opened toward the first mold, and an opening of the recess portion is covered with a plate in which a plurality of suction holes for suctioning the sheet material is drilled. According to the present invention, a hole can be created relatively easily in the sheet material that is firmly suctioned to the plate.

[7] In the present invention, it is preferable to form a hole after heating the sheet material. According to this configuration, a hole can be easily created in the softened sheet material.

[8] In the present invention, a separation portion that supports the heated sheet material so as the sheet material to be separated from the workpiece body in the non-bonded region may be provided. According to this configuration, the separation portion can prevent the sheet material from contacting the workpiece body in the non-bonded region, thereby preventing, before a hole is created in the sheet material, the sheet material from contacting the workpiece body.

### BRIEF DESCRIPTION OF DRAWINGS

FIG. 1 is an explanatory view schematically illustrating an embodiment of a layered workpiece forming device of the present invention.

FIG. 2 is an explanatory view schematically illustrating a first mold and a workpiece body of the present embodiment.

FIG. 3 is an explanatory view illustrating a through-hole of the present embodiment in an enlarged manner.

FIG. 4 is an explanatory view illustrating a state in which a hole is formed in a sheet material of the present embodiment.

FIG. 5 is an explanatory view schematically illustrating a shutter device as a comparative example.

### DESCRIPTION OF EMBODIMENTS

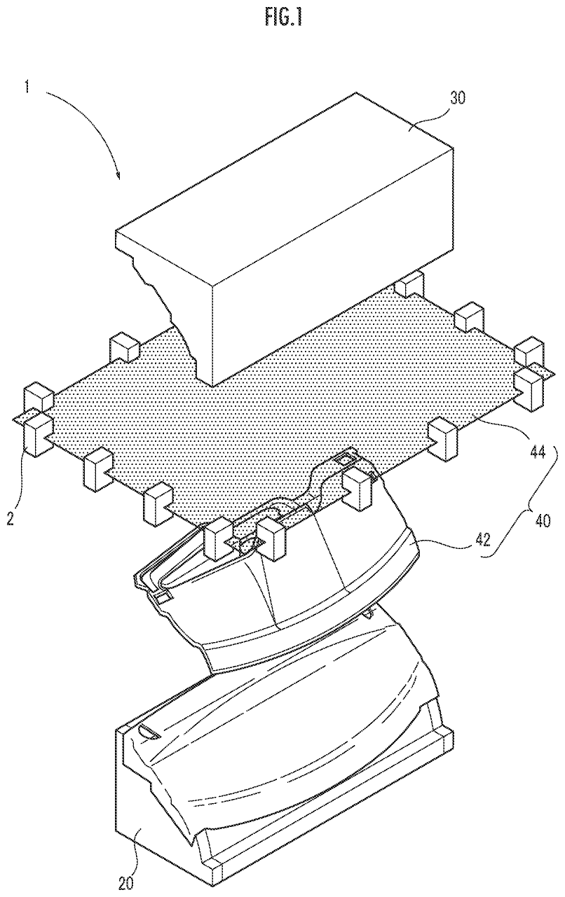

Embodiments of a layered workpiece forming device and a method for forming a layered workpiece of the present invention will be described with reference to the drawings. Referring to FIG. 1, a layered workpiece forming device 1 of the present embodiment includes a first mold 20 having a porous structure, and a second mold 30 having a porous structure. A layered workpiece 40 such as an instrument panel formed by the layered workpiece forming device 1 includes a workpiece body 42, and a sheet material 44 layered on the workpiece body 42.

The layered workpiece forming device 1 includes a plurality of clamps 2 that grips the periphery of the sheet material 44. The clamp 2 is movably supported by a support device (not illustrated) standing upward from the periphery of the first mold 20.

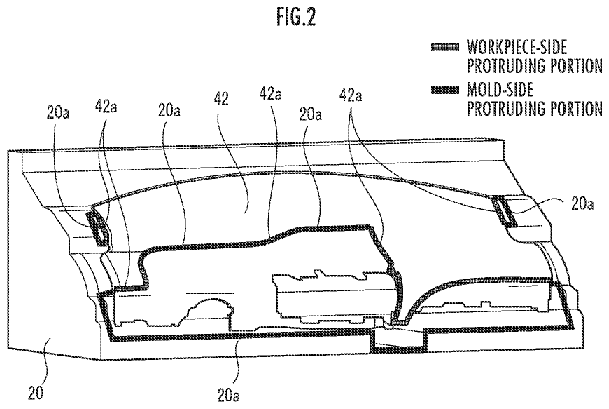

FIG. 2 illustrates a state in which the workpiece body 42 is placed on the first mold 20.

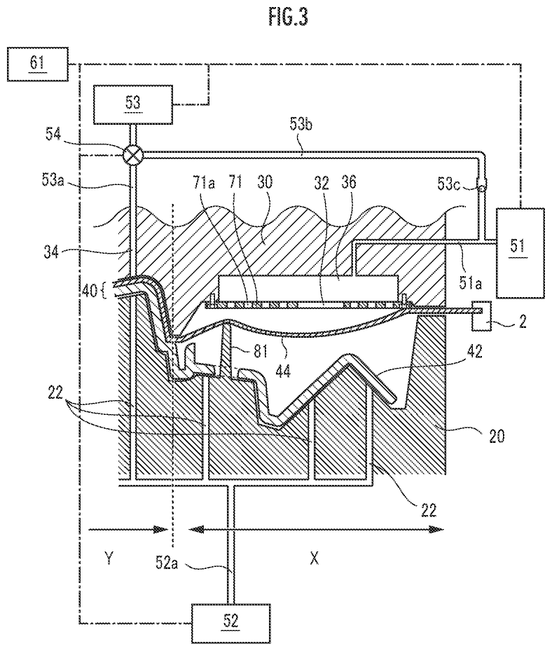

As illustrated in FIG. 3, a plurality of sucking holes 22 opened to a placement surface on which the workpiece body 42 is placed is provided in the first mold 20.

Taking advantage of the porous structure of the first mold 20, a plurality of continuous pores or open pores that already exist in the first mold 20 having a porous structure can be used as the sucking holes 22. On the inner surface of the second mold 30, a pattern such as embossing or satin to be transferred to the surface of the sheet material 44 is formed.

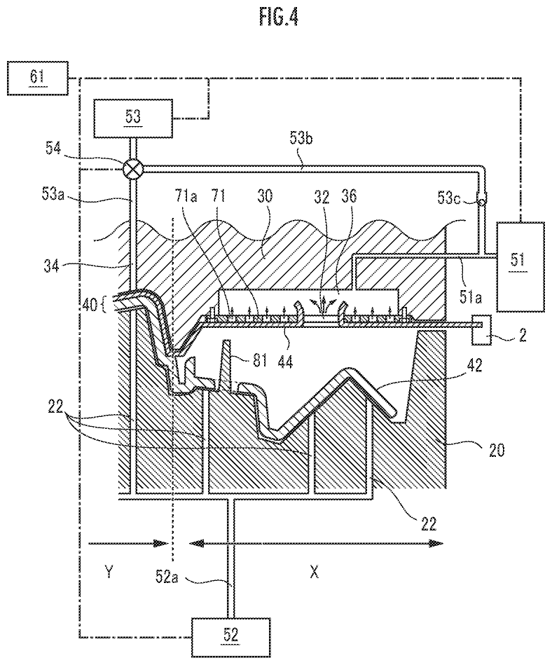

The second mold 30 is provided with a through-hole 32 penetrating the second mold 30 in such a manner as to be opened to a place on the periphery of the workpiece body 42 when the second mold 30 is overlapped with the first mold 20 with the workpiece body 42 and the sheet material 44 interposed between the second mold 30 and the first mold 20. A plate 71 is provided in such a manner as to cover an opening of a recess portion 36 formed in the inner surface of the second mold 30, and the through-hole 32 of the present embodiment is a hole drilled in the plate 71. As illustrated in FIG. 4, the through-hole 32 is set such that the sheet material 44 is partially tom when sucked. The plate 71 is provided with a plurality of suction holes 71a having a diameter smaller than that of the through-hole 32 so as the sheet material 44 to be suctioned onto the plate 71.

The second mold 30 is provided with an ejection hole 34 penetrating the second mold 30 in such a manner as to be opened to places in the central portion of the workpiece body 42, which central portion is a portion of the workpiece body 42 not including the periphery of the workpiece body 42. Although only one ejection hole 34 is illustrated in FIGS. 3 and 4, the ejection hole 34 is actually provided at each of a plurality of places. Taking advantage of the porous structure of the second mold 30, a plurality of continuous pores or open pores that already exist in the second mold 30 having a porous structure can be used as the ejection holes 34. In this case, in order to avoid the porous structure of the second mold 30 allowing the recess portion 36 to communicate with the ejection hole 34, a communication blocking process, for example, plating or solidifying with resin, may be applied to the recess portion 36 to block the communication between the recess portion 36 and the ejection hole 34.

The through-hole 32 drilled in the plate 71 is connected to a first sucking device 51 for sucking the sheet material 44 via a first connection pipe 51a. In the present embodiment, the through-hole 32 and the first sucking device 51 constitute a hole creating unit. A second sucking device 52 for sucking the workpiece body 42 is connected to the sucking holes 22 via a second connection pipe 52a. The ejection holes 34 in the second mold 30 are connected via a third connection pipe 53a to a gas supplying-and-sucking device 53 for supplying a gas such as air.

A bypass path 53b is connected to the first connection pipe 51a and the third connection pipe 53a. A check valve 53c that blocks the flow of gas from the third connection pipe 53a to the first connection pipe 51a is provided on the bypass path 53b. A flow path switching valve 54 is provided at a connection between the third connection pipe 53a and the bypass path 53b.

The flow path switching valve 54 is configured to be switchable between two states, that is, an “ejection-allowed state” and a “sucking-allowed state”. The “ejection-allowed state” is a state in which the gas supplying-and-sucking device 53 is connected to the ejection holes 34 via the third connection pipe 53a, and the connection between the ejection holes 34 and the first sucking device 51 via the bypass path 53b is cut. The “sucking-allowed state” is a state in which the first sucking device 51 is connected to the ejection holes 34 via the third connection pipe 53a, the bypass path 53b, and the first connection pipe 51a, and the connection between the ejection holes 34 and the gas supplying-and-sucking device 53 is cut.

Furthermore, referring to FIG. 2, the first mold 20 and the workpiece body 42 are respectively provided with mold-side protruding portions 20a and workpiece-side protruding portions 42a that project toward the second mold 30 and extend along the outer edge of a bonded region of the sheet material 44 so as to encircle a plurality of through-holes 32.

The layered workpiece forming device 1 includes a control unit 61 that controls the first sucking device 51, the second sucking device 52, the gas supplying-and-sucking device 53, and the flow path switching valve 54. The control unit 61 is an electronic control unit including a CPU, a memory, and the like, and controls the first sucking device 51, the second sucking device 52, the gas supplying-and-sucking device 53, and the flow path switching valve 54 by executing by using the CPU a control program stored in a storage unit such as a memory and transmitting an instruction signal.

As illustrated in FIG. 3, the first mold 20 is provided with a pin 81 (corresponding to a separation portion in the present embodiment) so as the sheet material 44 that has been heated by a heating device (not illustrated) and positioned between the second mold 30 and the workpiece body 42 not to come into contact with the non-bonded region X of the workpiece body 42 by hanging down due to the heating. In the present embodiment, the pin 81 is described as the separation portion, but the separation portion of the present invention is not limited to the pin 81. For example, a pin having a small tip area may be provided in the non-bonded region X of the workpiece body 42 so as to protrude upward, and the tip of the pin may support the sheet material 44 that has been heated and hangs down so as not to come into contact with the non-bonded region X of the workpiece body 42.

Next, a method for forming a layered workpiece using the layered workpiece forming device 1 will be described.

First, the first mold 20 and the second mold 30 are set in a separated state, and the workpiece body 42 is placed on the first mold 20. Then, the sheet material 44 gripped by the clamps 2 is heated by a heating device (not illustrated) and is then disposed between the workpiece body 42 and the second mold 30. At this time, as illustrated in FIG. 3, the sheet material 44 is supported by the pin 81 from below in the non-bonded region X, and the contact of the sheet material 44 with the workpiece body 42 is prevented. Then, the first mold 20 and the second mold 30 are brought closer to each other into a closed state.

Then, the control unit 61 switches the flow path switching valve 54 to the “ejection-allowed state” (the state in which the gas supplying-and-sucking device 53 is connected to the ejection holes 34 via the third connection pipe 53a so that the gas supplying-and-sucking device 53 can perform sucking via the ejection holes 34), and thereby the sheet material 44 is sucked by the gas supplying-and-sucking device 53 via the ejection holes 34 to be attached to the inner surface of the second mold 30. The pattern formed on the inner surface of the second mold 30 can thereby be transferred to a surface of the sheet material 44 (transfer step).

In this transfer step, the sheet material 44 is sucked by the first sucking device 51 via the through-hole 32, and the through-hole 32 tears the sheet material 44 in the non-bonded region X (see FIG. 4) to create a hole. The diameter of the through-hole 32 is set, based on the material and thickness of the sheet material 44, the heating temperature of the sheet material 44, and the sucking force of the first sucking device 51, so as a hole can be created in the sheet material 44.

Next, in a state where an adhesive is applied to the workpiece body 42 or the sheet material 44, the sheet material 44 is pressed against the workpiece body 42 and is bonded by the sucking force of the second sucking device 52 (bonding step).

Here, the sheet material 44 is not bonded to the entire surface of the workpiece body 42 but is bonded only to a portion to be exposed when an automobile or the like is assembled, and a portion such as the periphery to be hidden by other components during assembly is left unbonded to prevent assembly failure. The unbonded portion is cut away and discarded, leaving only the bonded portion.

Then, in the bonding step, the control unit 61 switches the flow path switching valve 54 to the “ejection-allowed state” (the state in which the gas supplying-and-sucking device 53 is connected to the ejection holes 34 via the third connection pipe 53a, and the connection of the ejection holes 34 to the first sucking device 51 via the bypass path 53b is cut), so that the gas supplying-and-sucking device 53 supplies a gas between the sheet material 44 and the second mold 30 via the ejection holes 34 to separate the sheet material 44 from the second mold 30.

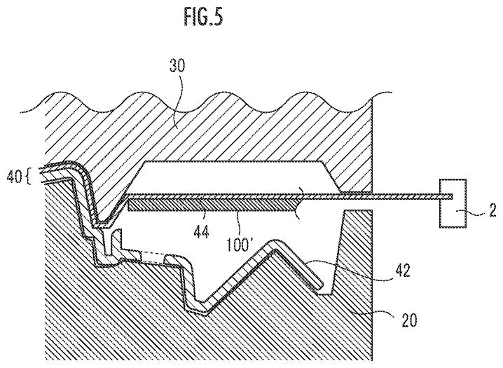

Since the unbonded portion located at the periphery of the workpiece body 42 has been sucked by the first sucking device 51 via the through-hole 32 to form a hole, the sheet material 44 is not sucked toward the workpiece body 42 in the non-bonded region X. Therefore, as illustrated in FIG. 5 as a comparative example, the present embodiment needs not be provided with a shutter device 100′ at the periphery of the workpiece body 42 to prevent bonding of the sheet material 44 to the periphery of the workpiece body 42. Therefore, there is no need to prepare a wide sheet material 44 to arrange the clamps on the outer side of the shutter device 100′ to avoid the shutter device 100′, so that the amount of the discarded portion of the sheet material 44 can be reduced and the manufacturing cost of the layered workpiece 40 can be suppressed.

Note that, in the present embodiment described above, the bypass path 53b for bypassing the first connection pipe 51a and the third connection pipe 53a is provided, and the flow path switching valve 54 is provided at the connection between the third connection pipe 53a and the bypass path 53b. However, the present invention is not limited to this configuration, and may be configured, for example, without the flow path switching valve 54.

In the present embodiment, the layered workpiece forming device 1 that creates a hole in the sheet material 44 by sucking by the sucking device as the hole creating unit has been described, but the hole creating unit of the present invention is not limited to this configuration. For example, the hole creating unit may be configured such that a protrusion that breaks through the sheet material is provided in the non-bonded region of the first mold or the second mold, and a hole is created in the sheet material by the protrusion.

In the present embodiment, the layered workpiece forming device 1 including the first sucking device 51 has been described. However, the present invention is not limited to this configuration. For example, the first sucking device 51 may be omitted, and the gas supplying-and-sucking device 53 may perform sucking through the through-hole 32 to create a hole in the non-bonded region X, which can reduce the size and cost of the layered workpiece forming device.

Furthermore, in the described present embodiment, in the transfer step, when transferring the pattern on the inner surface of the second mold 30 to the sheet material 44, a hole is simultaneously created in the non-bonded region X of the sheet material 44 by sucking by the first sucking device 51 through the through-hole 32. However, the step of creating a hole of the present invention is not limited to such a step. For example, a hole may be created before the transfer step, or a hole may be created in the non-bonded region X before the sheet material 44 sticks to the workpiece body 42 in the bonding step after the transfer step.

### REFERENCE SIGNS LIST

1 layered workpiece forming device
2 clamp
20 first mold
20a mold-side protruding portion
22 sucking hole
30 second mold
32 through-hole
34 ejection hole
36 recess portion
40 layered workpiece
42 workpiece body
42a workpiece-side protruding portion
44 sheet material
51 first sucking device
51a first connection pipe
52 second sucking device
52a second connection pipe
53 gas supplying-and-sucking device
53a third connection pipe
53b bypass path
53c check valve
54 flow path switching valve
61 control unit
71 plate
71a suction hole
81 support pin
100′ shutter device
X non-bonded region
Y bonded region

1. A method for forming a layered workpiece using a layered workpiece forming device including
a first mold configured to suction and hold the workpiece body, and
a second mold having on an inner surface a pattern that can be transferred to a surface of a sheet material to be layered on the workpiece body and configured to press the sheet material against the workpiece body,
to bond the sheet material to the workpiece body to form a layered workpiece,
the method comprising
a transfer step of attaching the sheet material to the second mold to transfer the pattern to the sheet material,
wherein
the first mold is provided with a sucking hole that penetrates the first mold to open at a portion that comes into contact with the workpiece body,
a sucking device for suctioning configured to suck the workpiece body is connected to the sucking hole, and
before or during sucking by the sucking device for suctioning, a hole is created in the sheet material in a non-bonded region to moderate sucking by the sucking device for suctioning so that the sheet material does not attach to the workpiece body in the non-bonded region that is not a bonded region.

2. The method for forming a layered workpiece according to claim 1, wherein
a hole is created in the sheet material in the non-bonded region after heating the sheet material.

3. A layered workpiece forming device comprising:
a first mold configured to suction and hold a workpiece body; and
a second mold having on an inner surface a pattern that can be transferred to a surface of a sheet material to be layered on the workpiece body, and configured to press the sheet material against the workpiece body,
wherein
a sucking hole for suctioning the workpiece body is provided in the first mold,
a sucking device for suctioning is connected to the sucking hole, and
the second mold includes a hole creating unit configured to create, before or during sucking by the sucking device for suctioning, a hole in the sheet material in a non-bonded region to moderate sucking by the sucking device for suctioning.

4. The layered workpiece forming device according to claim 3, wherein
the hole creating unit includes a through-hole provided in the inner surface of the second mold and in the non-bonded region, and a sucking device for creating hole that is configured to suck the sheet material through the through-hole to create a hole in the sheet material in the non-bonded region.

5. The layered workpiece forming device according to claim 4, wherein
the sucking device for creating hole is the sucking device for suctioning, and a hole is created in the sheet material in the non-bonded region by sucking the sheet material via the through-hole using the sucking device for suctioning.

6. The layered workpiece forming device according to claim 3, wherein
the second mold includes a recess portion opened toward the first mold, and
an opening of the recess portion is covered with a plate in which a plurality of suction holes for suctioning the sheet material is drilled.

7. The layered workpiece forming device according to claim 3, wherein
the hole is created after heating the sheet material.

8. The layered workpiece forming device according to claim 3, wherein
a separation portion configured to support the sheet material, that is heated, so as the sheet material to be separated from the workpiece body is provided in the non-bonded region.
